(19) United States
(12) Patent Application Publication
(10) Pub. No.: US 2011/0210533 A1
(43) Pub. Date: Sep. 1, 2011

(54) AIRBAG APPARATUS

(75) Inventor: Yuichi ADACHI, Kiyosu-shi (JP)

(73) Assignee: TOYODA GOSEI CO., LTD., Kiyosu-shi (JP)

(21) Appl. No.: 13/027,505

(22) Filed: Feb. 15, 2011

(30) Foreign Application Priority Data
Feb. 26, 2010 (JP) 2010-42108
Nov. 16, 2010 (JP) 2010-256129

(51) Int. Cl. B60R 21/203; B60R 21/20

(52) U.S. Cl. 280/728.2

(57) ABSTRACT

An airbag apparatus including an airbag is disclosed. The airbag includes a temporary joint that joins parts of the outer circumferential wall together in an disjointable fashion. The temporary joint includes a leading end that is so figured as to trigger disjointing. The airbag further includes a connecting element that extends from a vicinity of the leading end of the temporary joint and is disconnectably connected to an airbag housing or its vicinity by a distal end thereof. The connecting element is configured to be disconnected from the housing or its vicinity when an inner pressure of the airbag is increased. In an initial stage of airbag inflation, the connection of the connecting element to the housing or its vicinity helps suppress a tensile force acting on the leading end of the temporary joint such that the temporary joint is kept jointed and the airbag inflates in a small volume. The airbag is increased in volume upon disjointing of the temporary joint due to disconnection of the connecting element.

The Present application claims priority from Japanese Patent Application No. 2010-42108 of Adachi, filed on Feb. 26, 2010 and Japanese Patent Application No. 2010-256129 of Adachi, filed on Nov. 16, 2010, the disclosures of which are hereby incorporated into the present application by reference.

### BACKGROUND OF THE INVENTION

1. Field of the Invention

The present invention relates to an airbag apparatus including an airbag which includes an outer circumferential wall comprised of flexible sheet material, and is housed in a housing in a folded-up state and inflatable with inflation gas for emergence from the housing and deployment.

2. Description of Related Art

JP 2002-67849 discloses an airbag apparatus including an airbag. The airbag includes on the outer circumferential wall a temporary joint which joins parts of the outer circumferential wall together. In an initial stage of inflation, the airbag inflates with a suppressed volume due to joint by the temporary joint. Then right before full inflation, the temporary joint is broken and the airbag is allowed to inflate in a full volume.

Specifically, the outer circumferential wall of the airbag is comprised of two walls; a vehicle body side wall and occupant side wall which are respectively formed into a generally circular shape. The temporary joint is comprised of a tearable seam that joins together the two walls overlaid one above another in a concentric shape with the two walls. When the airbag, which has been initially inflated with a suppressed volume, cushions an occupant and is increased in inner pressure, sewing threads forming the temporary joint rupture and let the airbag inflate in a full volume.

However, with the configuration of the conventional airbag apparatus, the timing of disjointing of the temporary joint varies according to circumstances, because it relies on the increase of inner pressure due to contact of an occupant and also because the temporary joint is circular in shape and therefore has no portion which would trigger the rupture.

### SUMMARY OF THE INVENTION

An object of the present invention is to provide an airbag apparatus which is generally steady in timing of disjointing of the temporary joint and has a steady protecting property.

The object of the invention is achieved by a following airbag apparatus adapted to be mounted on a vehicle. The airbag includes an airbag folded up and housed in a housing for inflation with inflation gas and emergence from the housing. The airbag includes:

an outer circumferential wall made of flexible sheet material,

a temporary joint that joins parts of the outer circumferential wall together in an disjointable fashion, the temporary joint including a leading end that is so figured as to induce stress concentration and trigger disjointing; and

a connecting element that extends through an interior of the airbag from a vicinity of the leading end of the temporary joint and is disconnectably connected to the housing or a vicinity of the housing by a distal end thereof, the connecting element being configured to be disconnected from the housing or the vicinity thereof when an inner pressure of the airbag is increased.

In an initial stage of airbag inflation, the connection of the connecting element to the housing or the vicinity thereof makes areas of the outer circumferential wall of the airbag located outside of and in the vicinity of the leading end of the temporary joint pressed against each other due to an internal pressure owing to inflation gas so as to suppress a tensile force acting on the leading end of the temporary joint such that the temporary joint is kept jointed to make the airbag inflate in a small volume. The airbag is increased in volume upon disjointing of the temporary joint due to disconnection of the connecting element.

With the airbag apparatus thus configured, in an initial stage of inflation when the connecting element is connected to the housing or its vicinity, the airbag has a small volume with the temporary joint kept jointed. At this time, since the vicinity of the leading end of temporary joint, which joins parts of the outer circumferential wall of the airbag together, is drawn into an interior of the airbag by the connecting element extending from the vicinity of the leading end of the temporary joint and anchored to the housing, the areas of the outer circumferential wall of the airbag located outside of and in the vicinity of the leading end of the temporary joint are pressed against each other due to an internal pressure owing to inflation gas, so that a tensile force acting on the leading end of the temporary joint is suppressed. Therefore, the temporary joint is prevented from being subjected to the tensile force and the temporary joint is kept jointed while the connecting element is connected to the housing or its vicinity. Thereafter, when the airbag is increased in inner pressure, the connecting element is disconnected from the case or its vicinity, so that the temporary joint is no longer pulled toward an interior of the airbag and stress concentration occurs on the leading end due to a tensile force acting on the outer circumferential wall of the airbag. Then the temporary joint begins to disjoint from the leading end and the airbag is allowed to inflate in a full volume. That is, in the airbag apparatus of the invention, the temporary joint disjoints from the leading end immediately upon disconnection of the connecting element from the housing or its vicinity when an inner pressure of the airbag is increased, thereby generally stabilizing the timing of disjointing of the temporary joint.

Moreover, in the airbag apparatus of the invention, although the inner pressure of the airbag of small volume is increased when it cushions an occupant, the inner pressure is relatively lowered along with increase of volume of the airbag due to disconnection of the connecting element from the housing at a predetermined timing and subsequent disjoint of the temporary joint, thereby providing a soft cushioning effect.

Therefore, the airbag apparatus of the invention is generally steady in timing of disjointing of the temporary joint and has a steady protecting property.

It is desired that the above airbag apparatus includes on or in the vicinity of the housing an anchor mechanism that anchors the distal end of the connecting element and releases the leading end by actuation of an actuator.

This configuration will provide flexibility in setting the timing of disconnection of the connecting element from the housing, i.e., the timing of disjointing of the temporary joint, in comparison to an instance where the disconnection of the connecting element from the housing relies on tear of a tearable seam formed on the connecting element. Consequently, an adequate cushioning mode of the airbag depending on an impact pattern will be achieved by varying the timing of disjointing of the temporary joint adequately.

Moreover, it is desired in the above airbag apparatus that the temporary joint has a void region such that two terminals thereof are distantly located in the vicinity of the connecting element, and that the leading end of the temporary joint is comprised of the two terminals.

With the airbag apparatus thus constructed, when the connecting element is disconnected from the housing and stops pulling the temporary joint inwardly, a region of the outer circumferential wall to which the root portion of the connecting element is coupled enters into the void region formed between the two terminals or leading ends of the temporary joint and inflates in such a manner as to partially project outwardly from the void region. Then the projected portion so inflates as to broaden the void region, i.e., to disjoint the temporary joint, and therefore, the temporary joint disjoints smoothly and quickly from the terminals (leading ends).

Moreover, the temporary joint of the above airbag may be formed into a generally circle which is cut out at a part. This configuration will not cause a partial stress concentration on the temporary joint but help disperse the stress to the whole temporary joint. Therefore, the stress will securely concentrate on the two terminals (leading ends) upon disjointing of the temporary joint, such that the disjointing will securely start from the terminals (leading ends).

If the temporary joint of the airbag is formed by sewing with a sewing thread, manufacturing of the temporary joint will be facilitated in comparison with an instance of using adhesive or the like. Disjointing of the temporary joint will be facilitated, too, since once the sewing thread is ruptured, raveling will smoothly propagate to the whole joint. Especially if the temporary joint is generally formed into a circular shape, the temporary joint will be formed by a sewing machine automatically, not manually, by fixing the center of the temporary joint and using a jig or the like, thereby facilitating and saving costs in manufacturing the airbag.

Moreover, in the above instance, it is desired that no back stitch is applied to the terminals (leading end) of the temporary joint and the sewing threads at the terminals are just left untreated. With this configuration, raveling of the sewing threads at the terminals, not rupture of the threads, will trigger the disjointing of the temporary joint, which will help stabilize the timing of disjointing of the temporary joint as well as facilitate the disjointing.

If the above described airbag apparatus is configured for use for a steering wheel, it is desired that:

the outer circumferential wall of the airbag is comprised of an occupant side wall deployable toward an interior of a vehicle and a vehicle body side wall deployable on the side of the steering wheel, which have identical generally circular shapes;

the airbag further includes an edging joint that sews together outer edges of the occupant side wall and vehicle body side wall in a generally circular shape;

the temporary joint is smaller in diameter than the edging joint and is eccentrically located relative to the edging joint by locating a center of the temporary joint at the rear of a center of the edging joint; and

the two terminals of the temporary joint are located proximate a front end of the airbag.

It will also be appreciated, in an instance where the airbag apparatus is configured for use for a steering wheel, that the temporary joint joins the occupant side wall and vehicle body side wall together continuously on three sides of the airbag as fully inflated, from the left side to the right side via the front side except the rear side, in such a manner as to form a generally reverse-U shape and that the temporary joint includes a projecting portion that is formed into such a shape as to project partially proximate the front end of the airbag and a top of the projecting portion constitutes the leading end of the temporary joint.

With either configuration, the airbag firstly inflates in a small volume with the temporary joint kept jointed. The airbag of small volume has such an inflated contour that is reduced in width in a left and right direction and prevented from unfolding forwardly while being allowed to unfold rearward fully. Accordingly, the small-volume bag is capable of deploying quickly between a rear region of the ring of the steering wheel and an abdomen of an occupant, thereby preventing the steering wheel from hitting the occupant. Moreover, the small-volume bag is capable of avoiding engagement with hands and/or arms of the occupant holding the steering wheel. Then when the connecting element is disconnected from the housing or its vicinity, the temporary joint is disjointed from the two terminals or the top of the projecting portion located proximate the front end of the airbag, and the airbag is allowed to unfold forwardly as well as rearwardly along with disjointing of the temporary joint, and then fully inflate in a left and right direction as well. That is, with either configuration, the airbag quickly arrests an occupant in a small-volume state in the initial stage of inflation, and then as holding the occupant from moving forward, disjoints the temporary joint so as to inflate fully, thereby cushioning the head of the occupant softly, suppressing the reaction force, in a large-volume state. As a result, the airbag apparatus configured as described above quickly prevents forward movement of an occupant with the airbag of small volume which is high in inner pressure and protects the head of the occupant softly with the airbag of large volume which is suppressed in inner pressure.

Furthermore, if the airbag of the above airbag apparatus includes in an outer region of the leading end of the temporary joint on the outer circumferential wall a vent hole that is openable at disjointing of the temporary joint, the vent hole will release extra inflation gas when the temporary joint disjoints, thereby preventing an excessive increase of inner pressure of the airbag and providing an even softer cushioning effect.

### BRIEF DESCRIPTION OF DRAWINGS

FIG. 1 is a plan view of a steering wheel equipped with an airbag apparatus embodying the invention;

FIG. 2 is a schematic vertical section of the airbag apparatus of FIG. 1, taken along line II-II of FIG. 1;

FIG. 3 is a schematic perspective view of an airbag for use in the airbag apparatus of FIG. 1 as viewed from the front as the airbag is inflated by itself with the temporary joint kept jointed;

FIG. 4 is a partial enlarged vertical section of the front end region of the airbag of FIG. 3, showing the top of a projecting portion of a temporary joint;

FIG. 5 is a partial enlarged vertical section of the front end region of the airbag of FIG. 3, showing a front region of the temporary joint;

FIG. 6 is a schematic exploded perspective view of the airbag of FIG. 3;

FIG. 7 is a bottom view of the airbag of FIG. 3 flattened and reversed inside out;

FIG. 8 illustrates the way a region of the airbag of FIG. 3 in front of the inlet port is doubled up in order for a connecting element to project through a through hole;

FIG. 9 is a schematic bottom view of the airbag of FIG. 3 having the front region of the temporary joint invaginated into an interior of the airbag so the connecting element is taken out of the through hole;

FIG. 10 is a schematic partial enlarged section of a sewn seam (temporary joint);

FIG. 11 is a schematic vertical section of the airbag apparatus of FIG. 1 as the airbag is inflated with the connecting element anchored to the case;

FIG. 12 is a schematic vertical section of the airbag apparatus of FIG. 1 as the airbag is inflated with the connecting element released from the case and the temporary joint disjointed;

FIGS. 13A, 13B and 13C illustrate, by schematic plan views, the way the airbag of FIG. 3 makes transition from small volume to large volume along with disjointing of the temporary joint;

FIG. 14 is a bottom view of an airbag of an alternative embodiment as flattened and reversed inside out;

FIG. 15 is a schematic bottom view of the airbag of FIG. 14 having a front region of the temporary joint invaginated into an interior of the airbag so the connecting element is taken out of a through hole;

FIG. 16 is a schematic partial enlarged section of a terminal of a sewn seam (temporary joint) of the airbag of FIG. 14; and

FIGS. 17A, 17B and 17C illustrate, by schematic plan views, the way the airbag of FIG. 14 makes transition from small volume to large volume along with disjointing of the temporary joint.

### DESCRIPTION OF PREFERRED EMBODIMENTS

Preferred embodiments of the present invention are described below with reference to the accompanying drawings. In the preferred embodiments, the invention is described as applied to an airbag apparatus M mountable on a steering wheel. However, the invention is not limited to the embodiments disclosed herein. All modifications within the appended claims and equivalents relative thereto are intended to be encompassed in the scope of the claims.

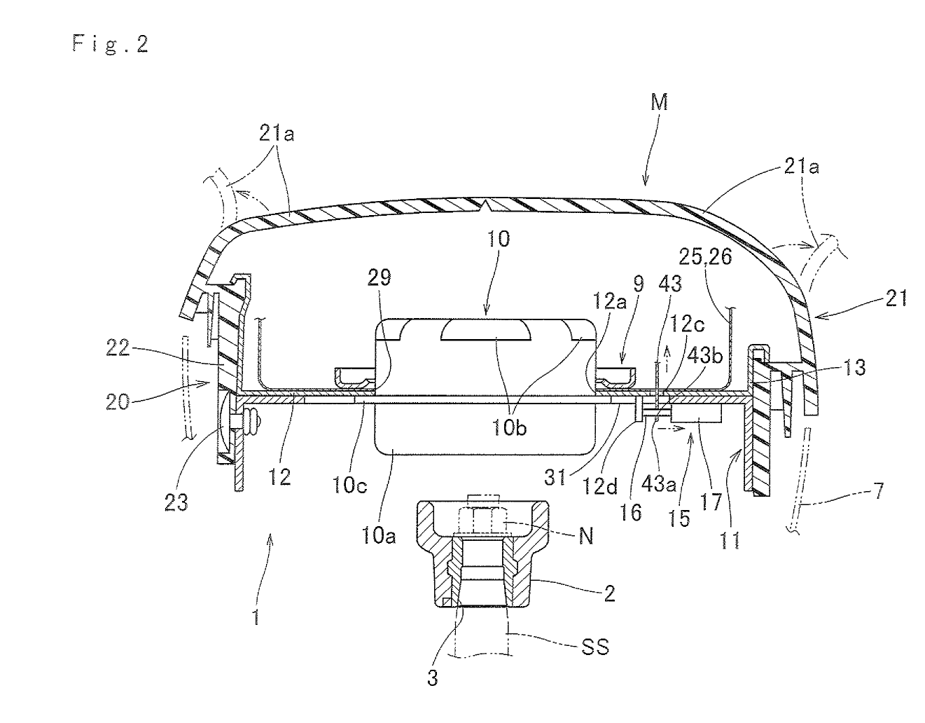

Unless otherwise specified, front/rear, up/down, and left/right directions in the embodiments are based on a steering wheel W mounted on a vehicle and steered straight ahead. Specifically, up/down direction is intended to refer to an up/down direction extending along an axial direction of a steering shaft SS (refer to FIGS. 2, 11 and 12) on which a steering wheel W is mounted. Front/rear direction is intended to refer to a front/rear direction of a vehicle extending orthogonal to the axial direction of the steering shaft SS, and left/right direction is intended to refer to a left/right direction of a vehicle extending orthogonal to the axial direction of the steering shaft SS.

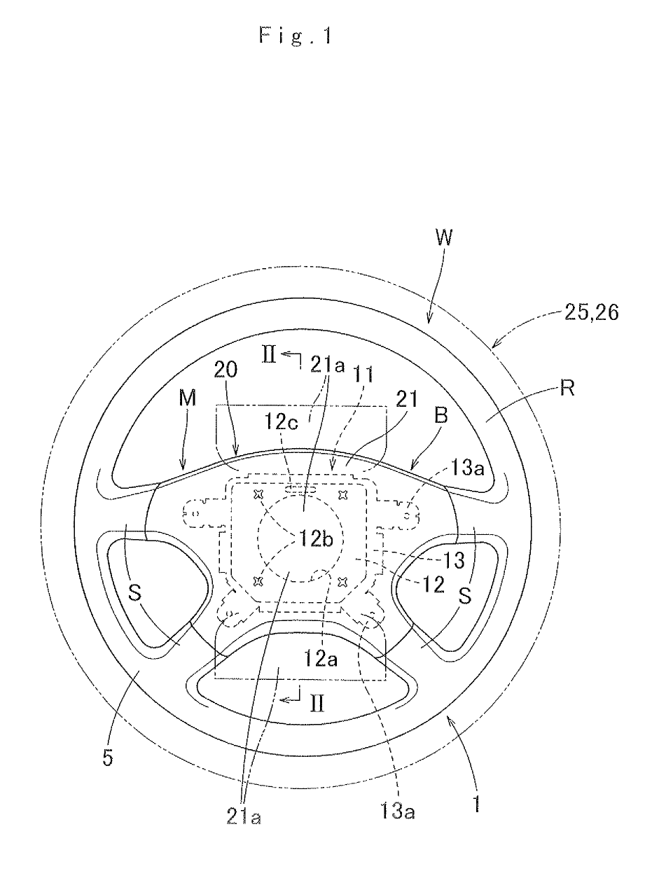

As shown in FIGS. 1 and 2, the steering wheel W of this specific embodiment includes a steering wheel body 1 and the airbag apparatus M mounted on top of a boss area B located at the center of the wheel body 1. The steering wheel body 1 includes an annular ring R for holding at steering operation, a boss area B located at the center of the ring R for connection with the steering shaft SS and a plurality of (four, in this embodiment) spokes S that connect the ring R and boss area B.

As shown in FIGS. 1, 2, 11 and 12, the wheel body 1 includes a wheel core 2, a cladding layer 5 and a lower cover 7. The wheel core 2 is fabricated of such metal as aluminum alloy and has such a contour that the ring R, boss area B and spokes S are interconnected. The cladding layer 5 is made from synthetic resin and covers the core 2 at the ring R and regions of the spokes S in the vicinity of the ring R. At an area of the core 2 corresponding to the boss area B is a steel boss 3 through which the steering shaft SS is inserted for nut N fixing. The lower cover 7 is made from synthetic resin and covers a lower region of the boss area B underneath the wheel body 1.

The airbag apparatus M is located at the boss area B at the center of the steering wheel Was shown in FIGS. 1, 2, 11 and 12, and includes an airbag 25 which is housed in a folded state, an inflator 10 for supplying the airbag 25 with inflation gas, a case or housing 11 which houses and holds the airbag 25 and inflator 10, an airbag cover 20 covering an upper side of the airbag 25, a retainer 9 that attaches the airbag 25 and inflator 10 to the case 11 and an anchor mechanism 15 that anchors a later-described connecting element 43 extending from the airbag 25 to the case 11. In this specific embodiment, the inflator 11 and anchor mechanism 15 are under control of a control device 46 (FIG. 11).

As shown in FIG. 11, the control device 46 is electrically connected with a crash sensor 47 or the like such as an acceleration sensor for detecting deceleration of a vehicle upon actual impact. The control device 46 actuates the inflator 10 upon receipt of an electric signal from the sensor 47, and then actuates a later-described actuator 17 of the anchor mechanism 15 upon lapse of a predetermined time period after receipt of the electric signal. More specifically, the control device 46 of this embodiment is so configured as to actuate the actuator 17 when the airbag 25 (bag body 26), which has inflated with a small volume with a later-described temporary joint 36 kept jointed, is increased in internal pressure upon cushioning an occupant.

The retainer 9 has a square annular shape so a later-described columnar body 10a of the inflator 10 is put through from the lower side. The retainer 9 is provided at four corners thereof with unillustrated bolts projecting downward. The retainer 9 is housed inside the airbag 25 with the bolts projecting from later-described mounting holes 30 of the airbag 25, which bolts are put through a bottom wall 12 of the case 11 and a flange 10c of the inflator 10 and fastened with nuts, thereby securing the airbag 25 and inflator 10 to the case 11.

The inflator 10 includes a body 10a and a flange 10c. The body 10a is substantially columnar in shape and is provided on top with gas discharge ports 10b. The flange 10c is formed into a square plate shape projecting from the outer circumference of the body 10a and has unillustrated through holes for receiving the bolts of the retainer 9.

As shown in FIGS. 1 and 2, the case or housing 11 is made of sheet metal and includes a bottom wall 12 having a rectangular plate shape and a side wall 13 extending vertically from an outer periphery of the bottom wall 12. The bottom wall 12 is provided with a circular insert hole 12a for receiving the body 10a of the inflator 10 from lower side. Around the insert hole 12a are four through holes 12b for receiving the bolts of the retainer 9 (FIG. 1). A through hole 12c is formed in front of the insert hole 12a and generally at the center in a left and right direction of the bottom wall 12 for receiving a leading end (distal end) 43a region of the connecting element 43 of the airbag 25. At the upper end of the side wall 13 are mounting tongues 13a (FIG. 1) extending outwardly, to which mounting tongues 13a mounting bases of unillustrated horn switches are secured. In this specific embodiment, the mounting bases are used to secure the case 11 to the core 2 of the steering wheel W. Thus the airbag apparatus M is mounted on top of the boss area B of the steering wheel body 1 attached to the steering shaft SS. Moreover, a later-described side wall 22 of the airbag cover 20 is attached to the side wall 13 of the case 11 with rivets 23 or the like.

There is located an anchor mechanism 15 on the underside of the bottom wall 12 of the case 11 and in the vicinity of the through hole 12c. The anchor mechanism 15 includes an anchor pin 16 put through an engagement hole 43b formed at the leading end 43a of the connecting element 43 of the airbag 25 and an actuator 17 secured to the underside of the bottom wall 12 for retracting the anchor pin 16. If the actuator 17 retracts the pin 16, the anchor pin 16 disengages itself from the through hole 43b and releases the leading end 43a of the connecting element 43. The actuator 17 can be any of a piston cylinder utilizing fluid pressure such as hydraulic pressure, water pressure, air pressure, or gas pressure which is generated by inflation gas discharged from the inflator, a motor utilizing such fluid pressure or electricity, an electromagnetic solenoid, a spring which exerts biasing force when restoring, or the like, provided that it can move the anchor pin 16 in response to an electric signal fed from the control device 46. As shown in FIG. 2, in a periphery (in the rear periphery, in this embodiment) of the through hole 12c opposite with respect to the actuator 17 on the underside of the bottom wall 12 is a support 12d for supporting the leading end of the anchor pin 16 and keeping the connecting element 43 anchored by the pin 16.

The airbag cover 20 is fabricated of synthetic resin and includes a ceiling wall 21 covering the housed airbag 25 from above and a side wall 22 having a generally square tubular shape extending downward from the vicinity of an outer periphery of the ceiling wall 21. The ceiling wall 21 includes two doors 21a which are adapted to open forward and rearward when pushed by the inflated airbag 25.

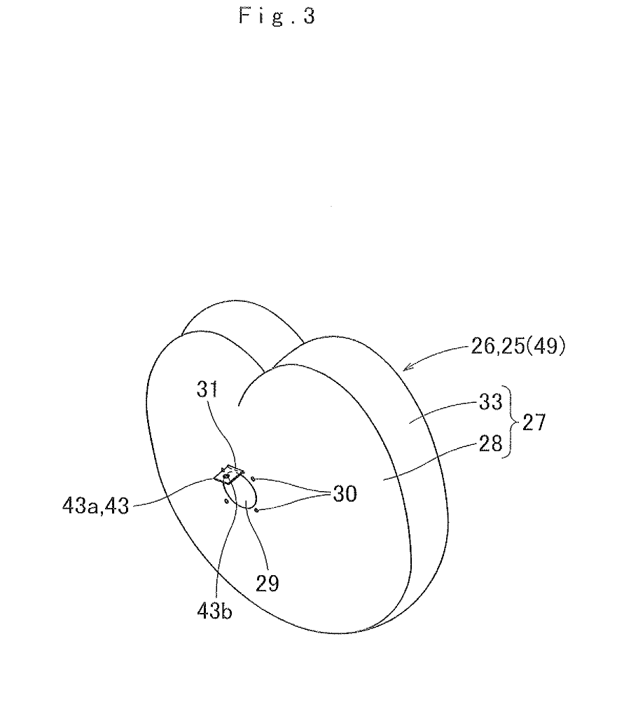

As shown in FIGS. 3 to 7, the airbag 25 includes a bag-shaped bag body 26 inflatable with inflation gas and a connecting element 43 extending from the outer circumferential edge 26a of the bag body 26.

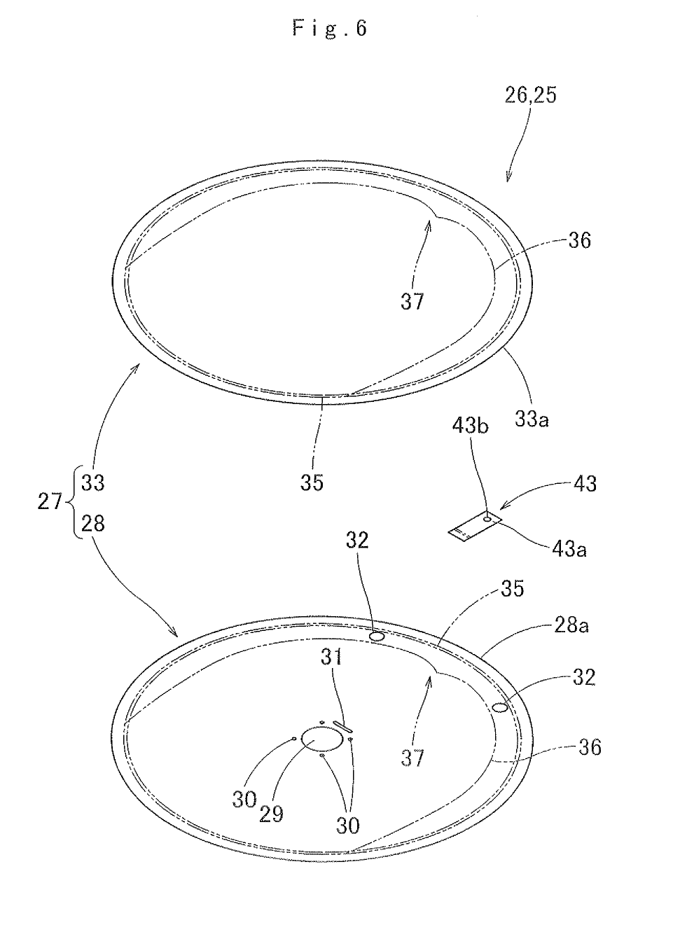

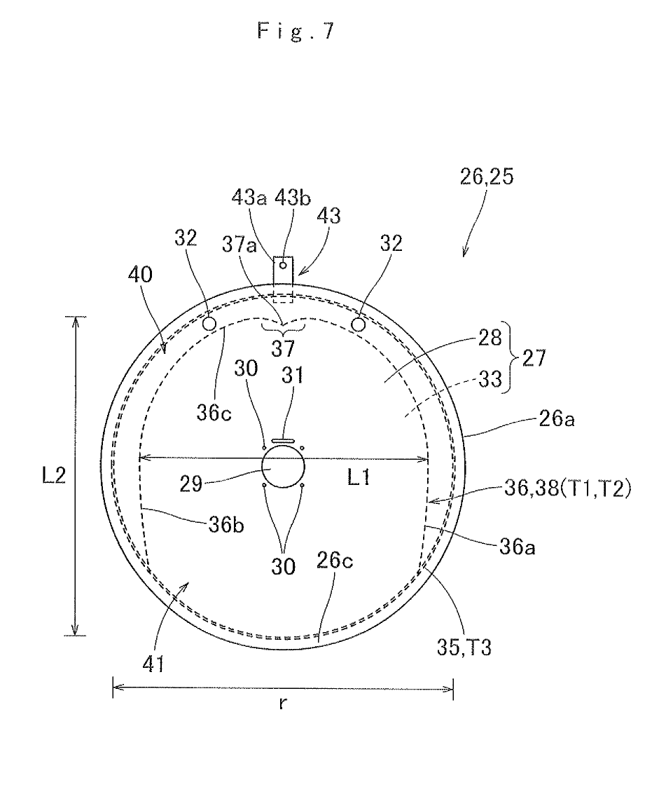

As shown in FIG. 1 (by double-dotted lines), 12 and 13, the bag body 26 is designed inflatable into a generally disc shape covering generally all over the top face of the steering wheel W. The outer circumferential wall 27 of the bag body 26 is made of flexible sheet material. The outer circumferential wall 27 in this embodiment is formed of flexible fabric woven of polyamide, polyester yarn or the like, and is comprised of a generally circular occupant side wall 33 deployable toward an interior of a vehicle at deployment and a generally circular vehicle body side wall 28 deployable on the side of the steering wheel W at deployment. The occupant side wall 33 and vehicle body side wall 28 are identical in outer contour. The bag body 26 is formed into a bag by sewing (connecting) together outer edges 28a and 33a of the vehicle body side wall 28 and occupant side wall 33 (FIGS. 6 and 7).

As shown in FIGS. 3, 6 and 7, the vehicle body side wall 28 includes at the center a circular inlet port 29 for receiving the inflator body 10a from below and admitting inflation gas discharged from the gas discharge ports 10b of the inflator 10. Around the inlet port 29 are four apertures 30 for receiving unillustrated bolts of the retainer 9. Further, a through hole 31 is formed at the front periphery of the inlet port 29 for receiving the leading end 43a of the connecting element 43.

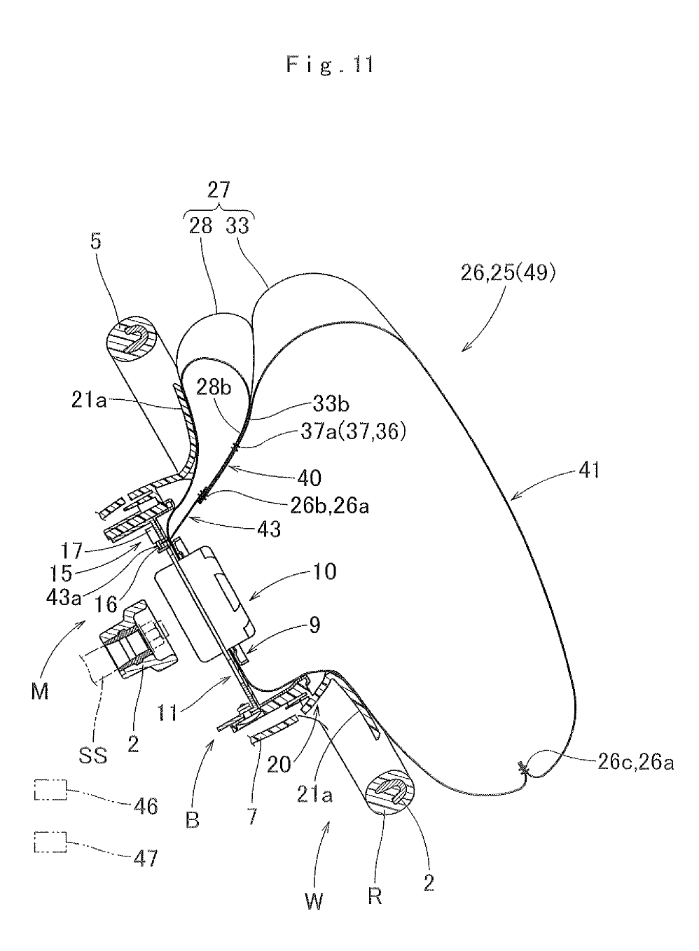

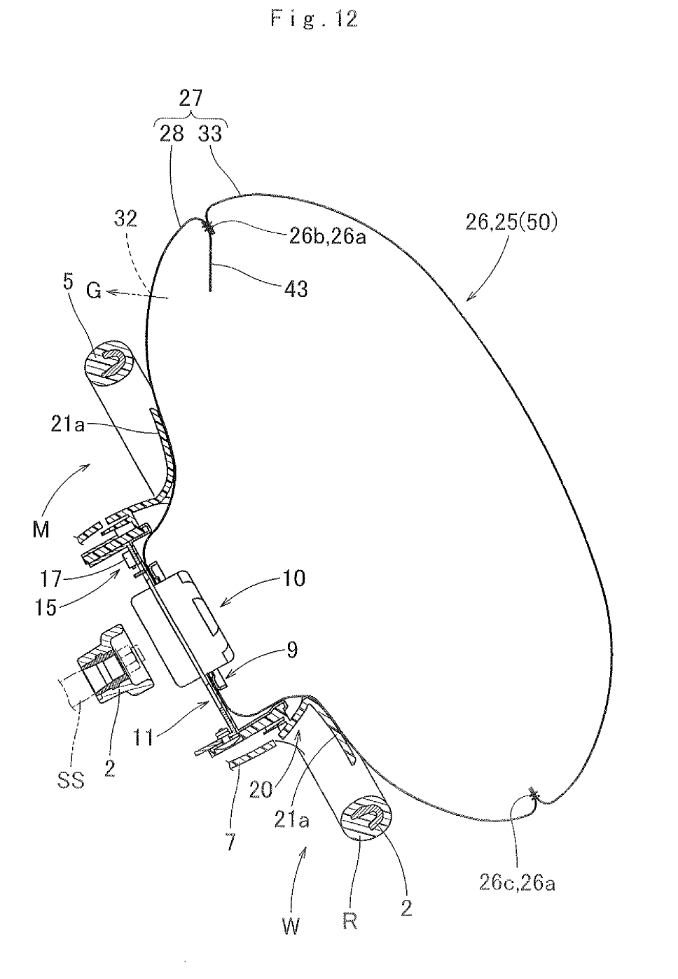

Moreover, as shown in FIGS. 6 and 7, two circular vent holes 32 are symmetrically formed in the vicinity of the front edge of the vehicle body side wall 28. These vent holes 32 are located on the side of the outer circumferential edge 26a of the bag body 26 relative to the top (leading end) 37a of projecting portion 37 of a later-described temporary joint 36. In other words, the vent holes 32 are located in a region (outer region 40) defined by the temporary joint 36 and a later-described edging joint 35 which is formed by joining the outer edges 28a and 33a of the vehicle body side wall 28 and occupant side wall 33 together, thus the vent holes 32 are closed off while the temporary joint 36 remains joined and open up when the temporary joint 36 is disjointed for releasing inflation gas G to the outside (FIG. 12).

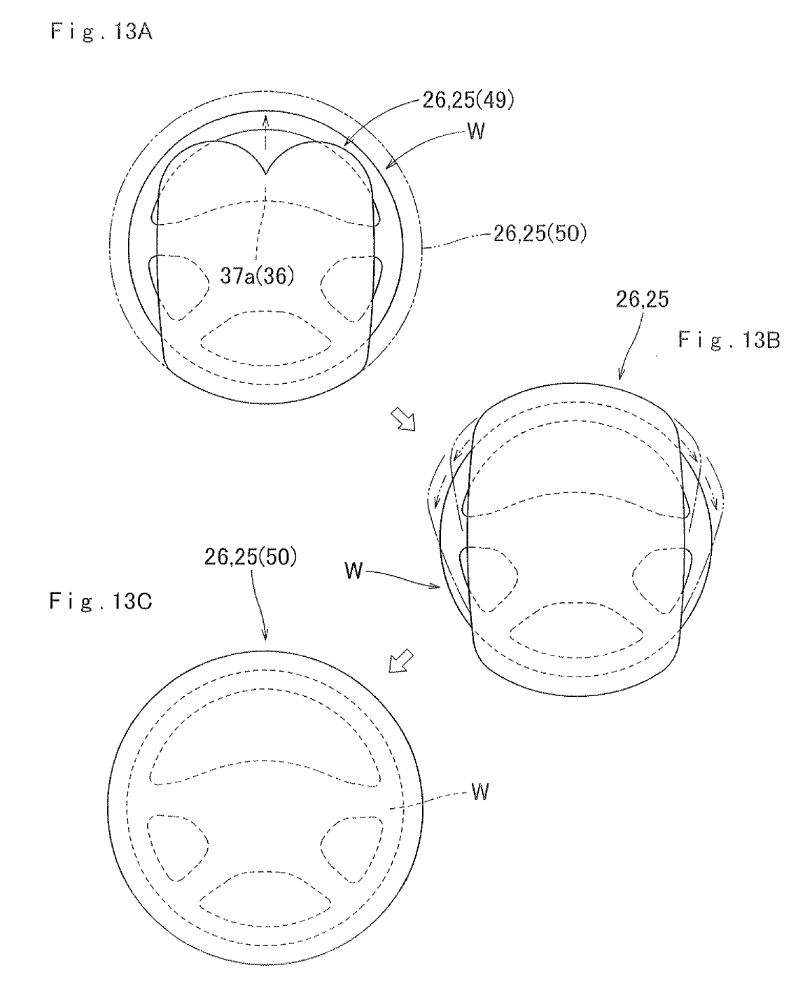

The bag body 26 includes on part of the outer circumferential wall 27 a temporary joint 36 that joins parts of the outer circumferential wall 27 together. In this specific embodiment, the temporary joint 36 joins the occupant side wall 33 and vehicle side wall 28 together continuously on three sides of the bag body 26 as fully inflated, from the left side to the right side via the front side, except a rear edge region 26c (i.e., a rear region of the inlet port 29), in such a manner as to divide an area of the bag body 26 into two (FIGS. 6 and 7). The outer region 40 of the bag body 26 that is surrounded by the temporary joint 36 and the edging joint 35, i.e., located on an outer area of the temporary joint 26, is so located as to be invaginated into an interior of the bag body 26 as shown in FIGS. 5 and 11. That is, an area defined by the temporary joint 36 and a rear part of the edging joint 35 constitutes an inner region 41 that inflates in a small volume in an initial stage of airbag inflation as shown in FIGS. 11 and 13A. When the temporary joint 36 disjoints, inflation gas G flows into the outer region 40 surrounded by the temporary joint 36 and edging joint 35 and the bag body 26 is allowed to inflate in a full volume as shown in FIGS. 12 and 13C.

More specifically, as shown in FIGS. 6 and 7, the temporary joint 36 is formed, on the occupant side wall 33 and vehicle body side wall 28 flattened and laid one above the other, into a generally reverse-U shape opening rearward as viewed from above. The temporary joint 36 includes a left region 36a extending generally in a front and rear direction from the edging joint 35 on the left of the inlet port 29, a right region 36b extending generally in a front and rear direction from the edging joint 35 on the right of the inlet port 29 and a front region 36c that connects the left region 36a and right region 36b in front of the inlet port 29, thus forming a symmetrical shape. In this specific embodiment, a clearance L1 (FIG. 7) between the left region 36a and right region 36b of the temporary joint 36 is about ⅞ of the outer diameter r of the flattened bag body 26, (which equals to an inner diameter of the edging joint 35). A clearance L2 (FIG. 7) between the front region 36c of the temporary joint 36 and the rear edge 26c of the bag body 26 is about 15/16 of the outer diameter r of the bag body 26.

Referring to FIGS. 6 to 8, the front region 36c of the temporary joint 36 Located proximate the front end of the airbag 25 (bag body 26) includes at the center in a left and right direction a projecting portion 37 which projects partially. In this embodiment, the projecting portion 37 is formed to project toward the inlet port 29, i.e., rearwardly, and includes a top 37a that is formed to induce stress concentration at the center in a left and right direction. As shown in FIG. 7, the projecting portion 37 of the embodiment is formed into such a shape that two arches are coupled together and converge at the top 37a. The top 37a of the projecting portion 37 constitutes a leading end that induces stress concentration and triggers disjointing of the temporary joint 36. In the temporary joint 36, a region extending from the left region 36a to the front region 36c and a region extending from the right region 36b to the front region 36c are smooth in shape, and therefore, even if the airbag 25 inflates with the connecting element 43 anchored to the case 11 and a tensile force exerted on the outer circumferential wall 27 of the airbag 25 acts on these regions of the temporary joint 36, the temporary joint 36 remains jointed at these regions.

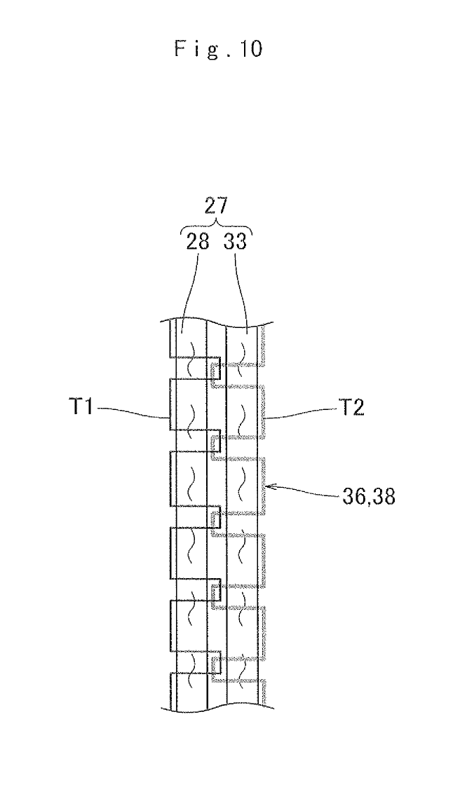

As shown in FIG. 10, the temporary joint 36 is comprised of a sewn seam 38 that sews the vehicle body side wall 28 and occupant side wall 33 together with two sewing threads T1 and T2. Out of the two sewing threads T1 and T2, the thread T1 has a less strength (thickness) than the other thread T2 so as to be rupturable when the actuator 17 is actuated to retract the anchor pin 16 and release the connecting element 43 upon airbag deployment. More specifically, the sewing threads T1 and T2 are made of the same material but the thread T1 is thinner than the thread T2, thus making a difference in thread strength. When the connecting element 43 is released from the anchor pin 16 after the bag body 26 inflates in a small volume, a stress concentration occurs on the top 37a (leading end) of the projecting portion 37 of the sewn seam 38 (temporary joint 36) and the thread T1 at the top 37a is ruptured. Then the ruptured thread T1 is pulled out of the seam successively and the seam (joint) is unseamed to the left region 36a and right region 36b. Further, the edging joint 35 of this specific embodiment, which joins the outer edges 28a and 33a of the vehicle body side wall 28 and occupant side wall 33 together, is comprised of a sewn seam formed by a sewing thread T3 (FIG. 7) that is stronger in thread strength than the sewing threads T1 and T2 and is unbreakable even at airbag inflation.

As shown in FIG. 7, the connecting element 43 is located at the center in a left and right direction of the front region 26b of the outer circumferential edge 26a of the bag body 26, i.e., in front of the projecting portion 37 of the temporary joint 36 in the vicinity of the top 37a of the projecting portion 37, inside the bag body 26, in such a manner as to extend in a front and rear direction. The connecting element 43 of this specific embodiment is made of a band-shaped cloth material separate from the bag body 26, and is coupled to the bag body 26 when the edging joint 35 of the bad body 26 is formed. As shown in FIGS. 2, 4 and 11, the leading end 43a of the connecting element 43 is passed through an interior of the bag body 26 and taken out of the through hole 31 formed in front of the inlet port 29 for engagement with the anchor mechanism 15 located on the underside of the bottom wall 12 of the case 11. The connecting element 43 includes at the leading end 43a an engagement hole 43b for receiving the anchor pin 16 of the anchor mechanism 15.

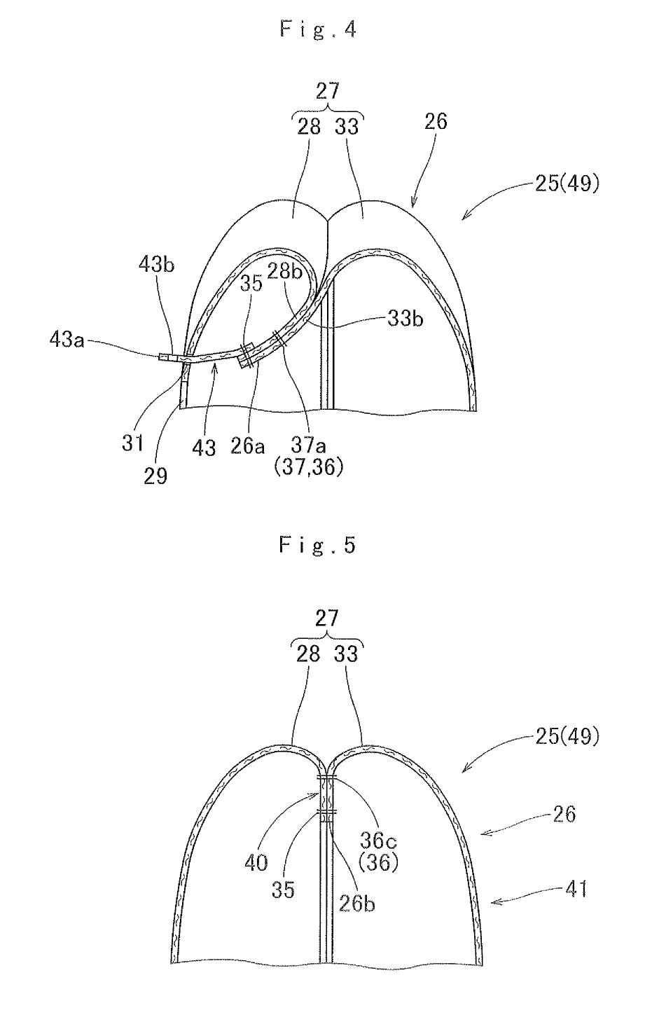

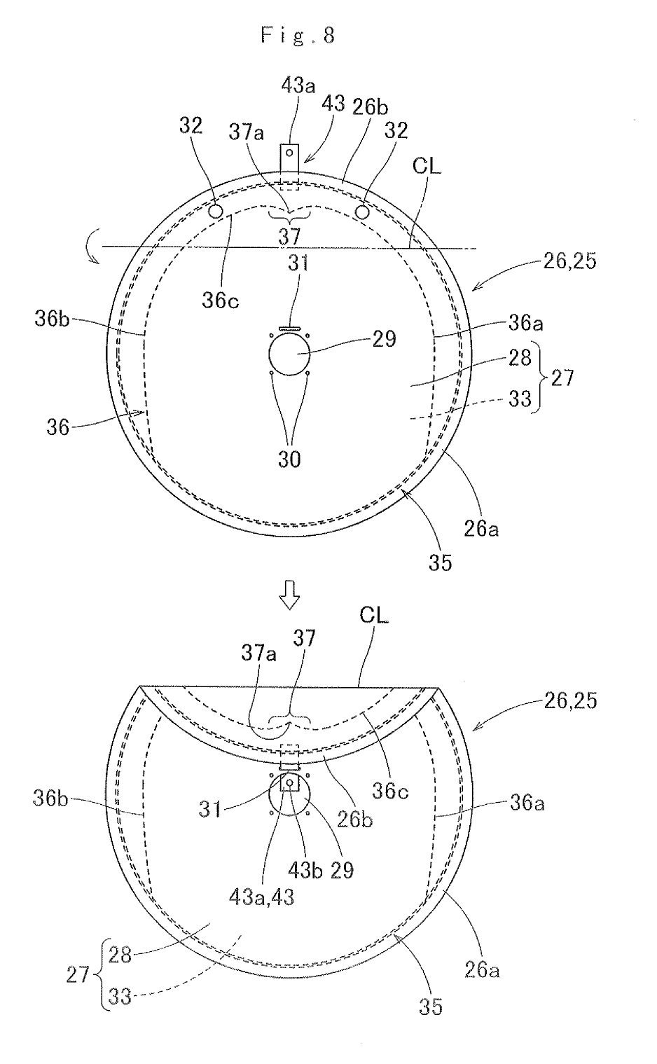

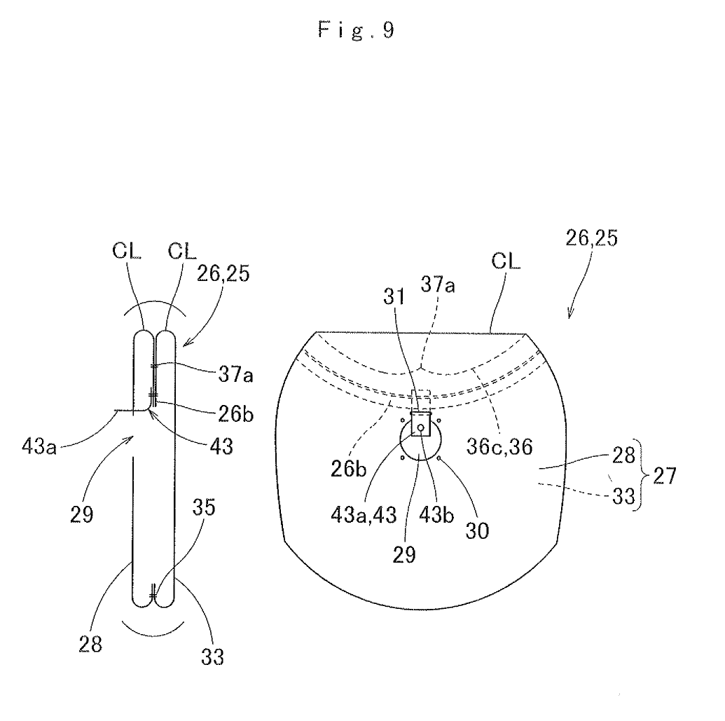

The length of the connecting element 43 is so designed that the connecting element 43 can draw the projecting portion 37 of the temporary joint 36 towards an interior of the airbag 25 (bag body 26) while being anchored to the anchor mechanism 15 in an initial stage of airbag inflation such that regions 28b and 33b of the vehicle body side wall 28 and occupant side wall 33 located to the outer circumferential edge 26a relative to the top 37a in the vicinity of the top 37a, i.e., regions of the vehicle body side wall 28 and occupant side wall 33 that is surrounded by the projecting portion 37, are pressed against each other as shown in FIGS. 4 and 11 and a tensile force which would otherwise act on the top 37a of the projecting portion 37a is suppressed. More specifically, the connecting element 43 is designed as short as possible. In order that the leading end portion 43a is taken out of the through hole 31, as shown in FIGS. 8 and 9, the vehicle body side wall 28 and occupant side wall 33 in a generally flattened state are doubled up at a position at the rear of the front region 36c of the temporary joint 36 (or on the side of the inlet port 29 relative to the front region 36c), in other words an area in front of the inlet port 29 is generally doubled up on a crease CL extending along a left and right direction so that the front edge 26b is brought close to the inlet port 29. In this embodiment, the crease CL is located slightly in front of the center in a front and rear direction of a clearance between the inlet port 29 and the front edge 26b of the bag body 26 generally flattened, as shown in FIG. 8. FIG. 8 illustrates the bag body 26 having its front area folded on the crease CL in a inside-out reversed state, and therefore, when the bag body 26 is actually mounted on a vehicle, the front area folded on the crease CL is invaginated into an interior of the bag body 26 as shown in FIG. 9.

How to manufacture the airbag 25 is now described. The occupant side wall 33 and vehicle body side wall 28 are overlaid one above the other so their outer surfaces confront each other and their outer edges 28a and 33a are matched. The connecting element 43 is located on a predetermined position between the occupant side wall 33 and vehicle body side wall 28. The sewing thread T3 is used to sew together the outer edges 28a and 33a of the occupant side wall 33 and vehicle body side wall 28, together with the root portion of the connecting element 43, thus forming the edging joint 35. Subsequently, the sewing threads T1 and T2 are used to sew the walls 28 and 33 to form the seam 38 (temporary joint 36). Thereafter, the vehicle body side wall 28 and occupant side wall 33 are reversed inside out utilizing the inlet port 29 so the edging joint 35 may not be exposed outside. Thus is formed the airbag 25 having the outer region 40 located outside of the temporary joint 36 invaginated into an interior.

To assemble the airbag apparatus M using the airbag 25 thus manufactured, the retainer 9 is firstly located inside the airbag 25 utilizing the inlet port 29 so the unillustrated bolts of the retainer 9 project from the mounting holes 30. Then each of the areas of the occupant side wall 33 and vehicle body side wall 28 located at the rear of the front region 36c of the temporary joint 36 is folded on the crease CL so the areas are invaginated, and then the leading end 43a of the connecting element 43 is taken out of the through hole 31. Thereafter, the airbag 25 is so folded up as to be housed in the case 11, and is wrapped up by a predetermined wrapping member for keeping the folded-up configuration. At this time, the bolts of the retainer 9 and the leading end 43a of the connecting element 43 are taken out of the wrapping member.

Subsequently, the airbag 25 is set on the bottom wall 12 of the case 11 such that the bolts of the retainer 9 project through the through holes 12b and the leading end 43a of the connecting element 43 projects through the through hole 12c. Then the anchor pin 16 of the anchor mechanism 15 is inserted through the engagement hole 43b formed at he leading end 43a of the connecting element 43, and the leading end of the anchor pin 16 is rested on the support 12d, thus the connecting element 43 is anchored by the anchor mechanism 15. Thereafter, the body 10a of the inflator 10 is set in the insert hole 12a of the bottom wall 12 from below whereas the bolts of the retainer 9 are put though the flange 10c and then nut fastened. Thus the airbag 25 and inflator 10 are housed in and secured to the case or housing 11 utilizing the retainer 9 and the connecting element 43 of the airbag 25 is connected to the case 11. Thereafter, the airbag cover 20 is placed over the case 11 and coupled with the side wall 13 of the case 11 by the side wall 22 with rivets 23 or the like. If unillustrated horn switches are then mounted on the mounting tongues 13a of the case 11, the airbag apparatus M is assembled. The airbag apparatus M is mounted on the steering wheel body 1 preliminarily secured to the steering shaft SS utilizing the unillustrated mounting bases of the horn switch mechanisms, and thus mounted on a vehicle.

If a moving car equipped with the airbag apparatus M cracks up, the control device 46 outputs an actuating signal to the inflator 10, and the inflator 10 discharges inflation gas from the gas discharge ports 10b to inflate the airbag 25, so that the airbag 25 pushes and opens the doors 21a of the airbag cover 20, and deploys.

In an initial stage of inflation, the connecting element 43 is connected to the case or housing 11, and the airbag 25 (bag body 26) firstly has a small volume with the temporary joint 36 kept joined as shown in FIGS. 11 and 13A. At this time, since the vicinity of the leading end (the top 37a of the projecting portion 37) of temporary joint 36, which joins parts of the outer circumferential wall 27 of the airbag 25 (the vehicle body side wall 28 and occupant side wall 33, in this embodiment) together, is drawn into an interior of the airbag 25 by the connecting element 43 extending from the vicinity of the top 37a and anchored to the case 11, the areas of the outer circumferential wall 27 of the airbag 25 located on the side of the outer circumferential edge 26a relative to the leading end (top 37a) and in the vicinity of the leading end (top 37a) are pressed against each other due to an internal pressure owing to inflation gas, so that a tensile force acting on the leading end (top 37a) is suppressed.

More specifically, the connecting element 43 is formed as short as possible and the front region 36c of the temporary joint 36 is considerably invaginated into an interior of the airbag 25 when the airbag 25 is housed in a folded-up configuration. However, since the airbag 25 tries to inflate spherically, regions of the temporary joint 36 except the projecting portion 37 are located on the outer surface of the airbag 25 in an initial stage of airbag inflation as shown in FIG. 5, and therefore subjected to a tensile force. On the other hand, the projecting portion 37 is so formed as to partially project toward the inlet port 29 (i.e., toward an interior of the airbag 25 as inflated) and is drawn into an interior of the airbag 25 (bag body 26) by the connecting element 43. This configuration does not allow the regions 28b and 33b of the vehicle body side wall 28 and occupant side wall 33 located on the side of the outer circumferential edge 26a relative to the top 37a, i.e., the regions of the vehicle body side wall 28 and occupant side wall 33 that is surrounded by the projecting portion 37, to inflate freely, and helps the regions 28b and 33b to be pressed against each other as shown in FIGS. 4 and 11 due to pressure of inflation gas. Therefore, the top 37a of the projecting portion 37 is prevented from being subjected to a tensile force and the temporary joint 36 is kept joined while the connecting element 43 is connected to the case 11 or its vicinity.

Thereafter, when the airbag 25 of small volume cushions an occupant and thus is increased in inner pressure, the actuator 17 is actuated to disconnect the connecting element 43 from the case 11, so that the top 37a (leading end) of the temporary joint 36 is no longer pulled toward an interior of the airbag 25 and stress concentration occurs on the top 37a due to a tensile force acting on the outer circumferential wall 27 of the airbag 25. Then the temporary joint 36 begins to be ruptured or disjoint from the top 37a (leading end) and the airbag 25 is allowed to inflate in a full volume as shown in FIGS. 12 and 13C. That is, in the airbag apparatus M, the temporary joint 36 disjoints from the top 37a (leading end) immediately upon disconnection of the connecting element 43 from the case 11 or its vicinity when the airbag 25 of small volume is increased in inner pressure, thereby generally stabilizing the timing of disjointing of the temporary joint 36.

Moreover, in the airbag apparatus M, although the inner pressure of the airbag 25 of small volume is increased when it cushions an occupant, the inner pressure is relatively lowered along with increase of volume of the airbag 25 due to disconnection of the connecting element 43 from the case 11 at a predetermined timing and subsequent disjoint of the temporary joint 36, thereby providing a soft cushioning effect.

Therefore, the airbag apparatus M embodying the invention is generally steady in timing of disjointing of the temporary joint 36 and has a steady protecting property.

In the foregoing embodiment, the connecting element 43 anchored by the anchor mechanism 15 located on the bottom wall 12 of the case 11 is disconnectable from the case 11 by actuating the actuator 17 of the anchor mechanism 15 to retract the anchor pin 16. This configuration will provide flexibility in setting the timing of disconnection of the connecting element 43 from the case (housing) 11, i.e., the timing of disjointing of the temporary joint, in comparison to an instance where the disconnection of the connecting element from the housing relies on tear of a tearable seam formed on the connecting element. That is, an adequate cushioning mode of the airbag 25 depending on an impact pattern will be achieved by varying the timing of disjointing of the temporary joint 36 adequately. Without considering such an advantageous effect, it will also be appreciated to locate a tearable seam weaker than the temporary joint on the connecting element for tear to disconnect the connecting element from the housing. In the foregoing embodiment, the control device 46 is configured to actuate the actuator 17 of the anchor mechanism 15 when a predetermined time period elapsed after receiving an electric signal from the crash sensor 47 upon frontal collision and the airbag 25 is increased in inner pressure by cushioning of an occupant. However, the timing of disconnecting of the connecting element 43 from the case 11 should not be limited thereby, but can be determined arbitrarily.

The airbag 25 in the foregoing embodiment includes on a region of the outer circumferential wall 27 located on the side of the outer circumferential edge 26a relative to the top 37a of the projecting portion 37 of the temporary joint 36, i.e., on a region of the vehicle body side wall 28 surrounded by the temporary joint 36 and edging joint 35, vent holes 32 openable upon disjointing of the temporary joint 36 (FIGS. 6 and 7). As shown in FIG. 12, the vent holes 32 release extra inflation gas G when the temporary joint 36 disjoints, thereby preventing an excessive increase of inner pressure of the airbag 25 and providing an even softer cushioning effect. Moreover, since the vent holes 32 are closed off in the airbag 25 of small volume (small-volume bag 49), the small-volume bag 49 is allowed to keep high inner pressure. Without considering such an advantageous effect, the airbag may have no vent holes.

In the foregoing embodiment, the temporary joint 36 is formed by sewing with two sewing threads T1 and T2. This configuration will facilitate manufacturing of the temporary joint 36 in comparison with an instance of using adhesive or the like, and facilitate disjointing of the temporary joint 36 as well, since once the sewing thread T1 is ruptured, raveling will smoothly propagate to the whole joint. Especially in the foregoing embodiment, the temporary joint 36 is comprised of the sewn seam 38 that sews the vehicle body side wall 28 and occupant side wall 33 together with the sewing threads T1 and T2 which have different thread strengths. When the connecting element 43 is disconnected from the case 11 and stops pulling the temporary joint 36 toward an interior of the airbag 25, a stress due to a tensile force acting on the outer circumferential wall 27 of the airbag 25 will concentrate on the sewing thread T1 of weak strength at the top 37a (leading end) of the projecting portion 37 of the temporary joint 36 and the thread T1 at the top 37a will be easily ruptured, thereby disjointing the temporary joint 36 quickly. Without considering such an advantageous effect, however, the temporary joint may be formed by two sewing threads having equal strengths. Moreover, the temporary joint should not be limited to a sewn seam using a sewing thread. By way of example, the temporary joint may also be formed by adhering predetermined regions of the occupant side wall and vehicle body side wall by an adhesive such that the adhered regions are separated upon disconnection of the connecting element from the case.

The airbag apparatus M of the foregoing embodiment is configured for use for a steering wheel and the temporary joint 36 is formed to join the occupant side wall 33 and vehicle body side wall 28 together continuously on three sides of the airbag 25 as fully inflated, from the left side to the right side via the front side except the rear side, in such a manner as to form a generally reverse-U shape. Moreover, the temporary joint 36 includes proximate the front end of the airbag 25 (i.e., on the front region 36c) the projecting portion 37 formed into such a shape as to partially project rearwardly (i.e., toward the inlet port 29), and the top 37a of the projecting portion 37 constitutes the leading end of the temporary joint 36 that triggers, i.e., becomes the starting point of, disjointing of the temporary joint 36. In operation of the airbag apparatus M thus configured, the airbag 25 firstly inflates as the small-volume bag 49 with the temporary joint 36 kept jointed. Specifically, as shown in FIG. 13A, the small-volume bag 49 has such an inflated contour that is reduced in width in a left and right direction and prevented from unfolding forwardly while being allowed to unfold rearward fully. Accordingly, the small-volume bag 49 is capable of deploying quickly between a rear region of the ring R of the steering wheel W and an abdomen of an occupant, thereby preventing the steering wheel W from hitting the occupant. Moreover, the small-volume bag 49 is capable of avoiding engagement with hands and/or arms of the occupant holding the steering wheel W. Then when the connecting element 43 is disconnected from the case 11, the temporary joint 36 is disjointed from the top 37a of the projecting portion 37, and the airbag 25 is allowed to unfold forwardly as well as rearwardly along with disjointing of the front region 36c of the temporary joint 36 (FIG. 13B), and then fully inflate in a left and right direction as well, as shown in FIG. 13C.

That is, the airbag apparatus M quickly arrests an occupant with the airbag 25 (small-volume bag 49) in the initial stage of inflation, and then as holding the occupant from moving forward, disjoints the temporary joint 36 so the airbag 25 inflates fully, thereby cushioning the head of the occupant softly, suppressing a reaction force, with the large-volume bag 50. As a result, the airbag apparatus M quickly prevents forward movement of an occupant with the small-volume bag 49 which is high in inner pressure and protects the head of the occupant softly with the large-volume bag 50 which is suppressed in inner pressure.

With the configuration of the foregoing embodiment, the temporary joint 36 is formed by forming the sewn seam 38 with the sewing threads T1 and T2 when sewing together the outer edges 28a and 33a of the occupant side wall 33 and vehicle body side wall 28 to form the edging joint 35. Further, forming of the temporary joint 36 only requires two-dimensional sewing. Moreover, the connecting element 43 is also coupled to the airbag 25 when forming the edging joint 35. Therefore, the above configuration of the airbag apparatus M conduces to facilitate and save costs in manufacturing the airbag 25, thereby providing a low-cost airbag 25.

Although the projecting portion 37 of the temporary joint 36 is formed to project rearwardly (i.e., toward the inlet pot 29) in the foregoing embodiment, the projecting direction of the projecting portion should not be limited thereby. The projecting portion of the temporary joint may also be formed to project forward as long as the areas of the outer circumferential wall of the airbag located outside of top of the temporary joint are pressed against each other due to an inner pressure owing to inflation gas when the airbag is inflated in a small volume.

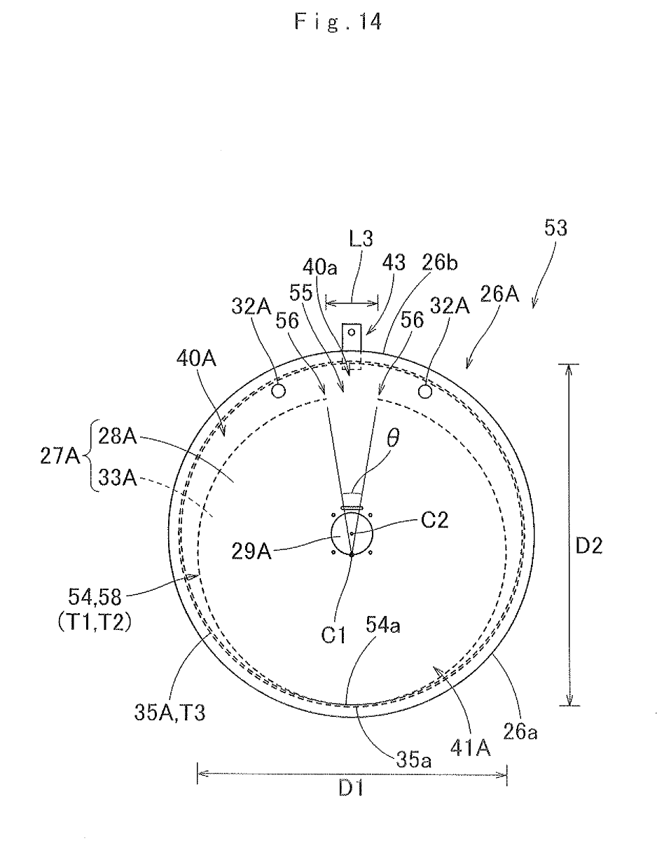

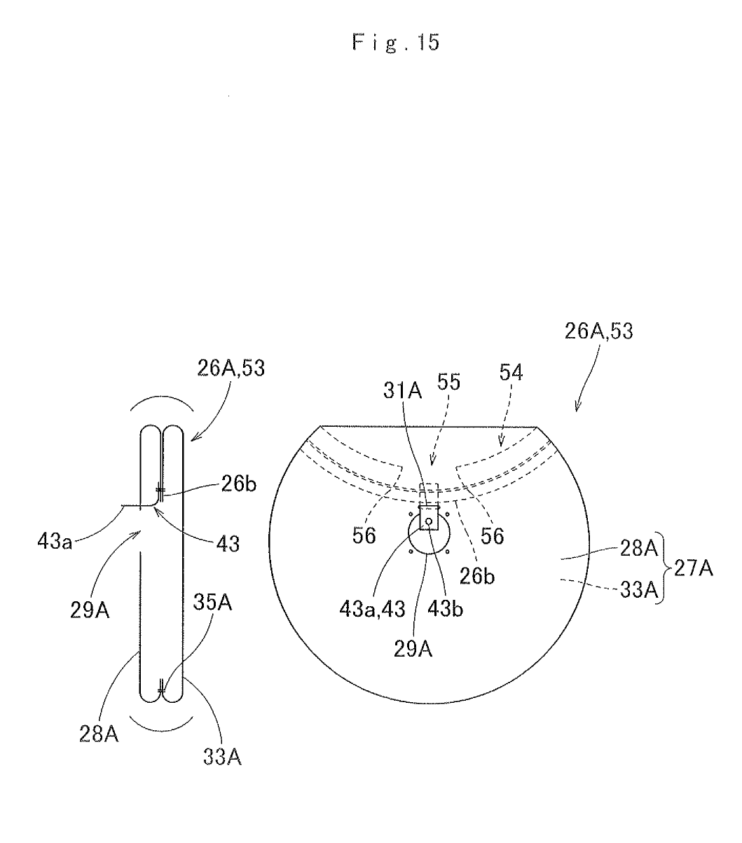

An alternative embodiment of the invention is now described. An airbag 53 shown in FIGS. 14 and 15 is configured for use for an airbag apparatus for a steering wheel, and includes an airbag body 26A inflatable with inflation gas and a connecting element 43 extending from the outer circumferential edge 26a of the bag body 26A. The connecting element 43 is identical in structure to that of the foregoing embodiment, and therefore, detailed description will be omitted. The bag body 26A is similar in structure to the bag body 26 of the airbag 25 except a temporary joint 54. Therefore, detailed descriptions for common members will be omitted while assigning “A” to the ends of common reference numerals.

Similarly to the bag body 26 of the airbag 25, the temporary joint 54 of the airbag 53 is formed into a generally circular shape which is smaller in diameter relative to a circular edging joint 35A that joins together outer edges 28a and 33a of the vehicle body side wall 28A and occupant side wall 33A, as shown in FIG. 14. Specifically, the temporary joint 54 is formed into such a shape that encircles the inlet port 29A inside the outer edge (edging joint 35A) and divides an area of the airbag 53 into inner and outer areas. In this specific embodiment, an outer diameter D1 of the temporary joint 54 is about 5/9 of an outer diameter D2 of the edging joint 35A as shown in FIG. 14. The temporary joint 54 is eccentrically located relative to the edging joint 35A by locating the center C1 of the temporary joint 54 at the rear of the center C2 of the edging joint 35A, and has the rear edge 54a coincide with the rear edge 35a of the edging joint 35A. The temporary joint 54 divides an area of the bag body 26A (an area inside the edging joint 35A) into an outer region 40A and an inner region 41A in this embodiment, too. In this embodiment, the temporary joint 54 is partially cut out at a generally center in a left and right direction proximate the front end of the airbag 53 between the center C1 and connecting element 43. In other words, the temporary joint 54 is so cut off that two terminals 56 thereof are distantly located in the vicinity of the connecting element 43 extending from the center in a left and right direction of the front edge 26b of the bag body 26A (i.e., in the rear of the connecting element 43). That is, the temporary joint 54 has a void region 55 so that the outer region 40A is communicated with the inner region 41A at the rear of the connecting element 43, and the two terminals 56 located on both sides of the void region 55 in the vicinity of the connecting element 43 constitute the leading ends that triggers the disjointing of the temporary joint 54. The distance L3 between the terminals 56 of this specific embodiment is about ⅙ of the outer diameter D1 of the temporary joint 54 as shown in FIG. 14. The crossing angle θ of two straight lines connecting each of the terminals 56 and the center C1 is about 20°. Further, the temporary joint 54 is formed into a symmetrical contour relative to a straight line that runs through the center of the bag body 26A (which coincides with the center C2 of the edging joint 35A) in a front and rear direction.

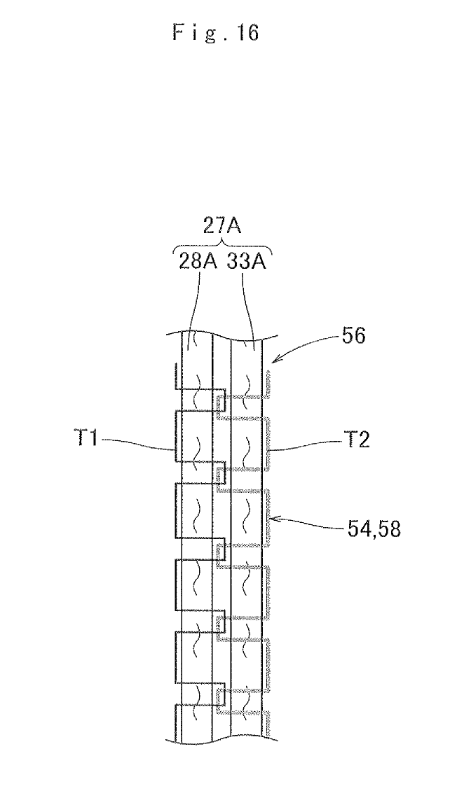

Similarly to the foregoing embodiment, the temporary joint 54 is comprised of a sewn seam 58 that sews together the vehicle body side wall 28A and occupant side wall 33A with two sewing threads T1 and T2 which are weaker in strength than the sewing thread T3 forming the edging joint 35A. As shown in FIG. 16, back stitch is not applied to the terminals 56 of the temporary joint 54. The terminals 56 are formed by merely cutting off the sewing threads T1 and T2 thereat. To paraphrase, such terminal treatment as back stitch for preventing unseaming or raveling of the sewing threads T1 and T2 is not applied to the terminals 56 of the temporary joint 54. Two vent holes 32A are located in a region (outer region 40A) defined by the temporary joint 54 and the edging joint 35A, similarly to the foregoing embodiment.

Manufacturing of the airbag 53 is conducted similarly to the airbag 25 of the foregoing embodiment. The bag body 26A is formed by sewing together the occupant side wall 33A and vehicle body side wall 28A to form the edging joint 35A and then the sewn seam 58 (temporary joint 54) is formed by the sewing threads T1 and T2. Thereafter, the vehicle body side wall 28A and occupant side wall 33A are reversed inside out utilizing the inlet port 29A so the edging joint 35A may not be exposed outside, as shown in FIG. 15.

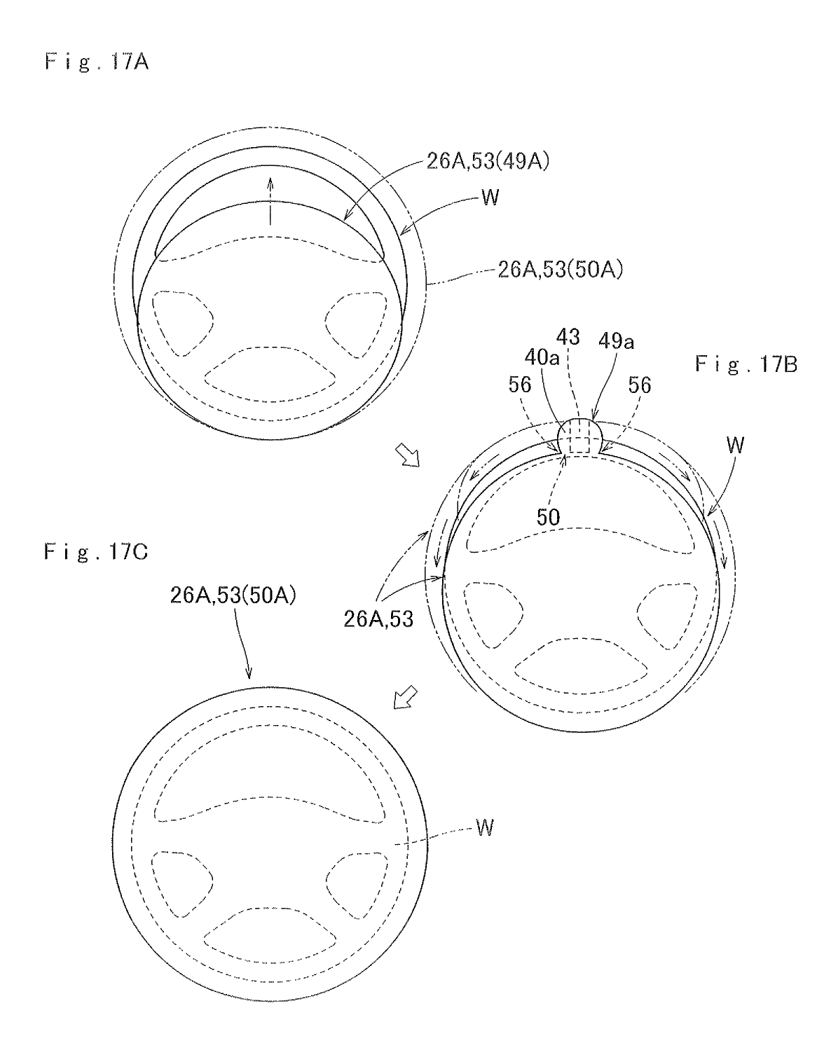

With the airbag apparatus equipped with the airbag 53 thus constructed, the airbag 53 (bag body 26A) firstly has a small volume in an initial stage of inflation with the temporary joint 54 kept joined as shown in FIGS. 17A. At this time, since the vicinity of the leading ends (the terminals 56) of the temporary joint 54, which joins parts of the outer circumferential wall 27A of the airbag 53 (the vehicle body side wall 28A and occupant side wall 33A) together, is drawn into an interior of the airbag 53 by the connecting element 43, the areas of the outer circumferential wall 27A of the airbag 53 located on the side of the outer circumferential edge 26a relative to the leading ends (terminals 56) and in the vicinity of the leading ends (terminals 56) are pressed against each other due to an inner pressure of inflation gas, so that a tensile force acting on the leading ends (terminals 56) is suppressed. Therefore, the terminals 56 of the temporary joint 54 are prevented from being subjected to the tensile force and the temporary joint 54 is kept jointed while the connecting element 43 is connected to an unillustrated case or its vicinity.

Thereafter, when the airbag 53 of small volume cushions an occupant and thus is increased in inner pressure, an unillustrated actuator is actuated to disconnect the connecting element 43 from the case, so that stress concentration occurs on the terminals 56 (leading ends) of the temporary joint 54 due to a tensile force acting on the outer circumferential wall 27A of the inflated airbag 53. Then the temporary joint 54 ruptures or disjoints from the leading ends (terminals 56) and the airbag 53 is allowed to inflate in a full volume as shown in FIG. 17C.

Specifically, when the connecting element 43 is disconnected from the case and stops pulling the temporary joint 54 inwardly, a region of the outer circumferential wall 27A to which the root portion of the connecting element 43 is coupled (i.e., a part 40a of the outer region 40A) enters into the void region 55 formed between the terminals (leading ends) 56 of the temporary joint 54 and inflates in such a manner as to partially project outwardly from the void region 55 (FIG. 17B). Then the projected portion (the part 40a of the outer region 40A) so inflates as to broaden the void region 55, i.e., to separate the vehicle body side wall 28A and occupant side wall 33A, and therefore, the temporary joint 54 disjoints smoothly and quickly from the terminals (leading ends) 56.

Moreover, the temporary joint 54 of the airbag 53 is formed into a generally circle which is cut out at a part. This configuration will not cause a partial stress concentration on the temporary joint 54 but help disperse a stress to the whole temporary joint 54. Therefore, the stress will steadily concentrate on the two terminals (leading ends) 56 upon disjointing of the temporary joint 54, such that the disjointing of the temporary joint 54 will steadily start from the terminals (leading ends) 56. Without considering such an advantageous effect, however, the contour of the temporary joint should not be limited thereby. By way of example, it may also be comprised of a series of curved lines having different curvatures.

Since the temporary joint 54 of the airbag 53 is formed by sewing with two sewing threads T1 and T2, too, manufacturing of the temporary joint 54 will be facilitated in comparison with an instance of using adhesive or the like. Disjointing of the temporary joint 54 will be facilitated, too, since once the sewing threads T1 and T2 are ruptured, raveling will smoothly propagate to the whole joint. Especially in the airbag 53, a generally circular temporary joint 54 is formed by sewing using the sewing threads T1 and T2. This temporary joint 54 will be formed by a sewing machine automatically, not manually, by fixing the center C1 of the temporary joint 54 and using a jig or the like, thereby facilitating and saving costs in manufacturing the airbag 53.

Moreover, in the airbag 53, no back stitch is applied to the terminals 56 of the temporary joint 54 and the sewing threads T1 and T2 are just left untreated. With this configuration, raveling of the sewing threads T1 and T2 at the leading ends (terminals 56), not rupture of the threads T1 and T2, will trigger the disjointing of the temporary joint 54, which will help stabilize the timing of disjointing of the temporary joint 54 as well as facilitate the disjointing. Applying no back stitch will enable both of the terminals 56 to ravel generally simultaneously. Without considering such an advantageous effect, the temporary joint may be formed with back-stitched terminals. In the airbag 53, although disjointing of the temporary joint 54 begins with raveling of the sewing threads T1 and T2 in the vicinity of the terminals 56, the threads T1 and T2 will also rupture at a later stage of disjointing.

Similarly to the foregoing embodiment, the airbag 53 is configured for use for an airbag apparatus for a steering wheel. The temporary joint 54 is smaller in diameter than the edging joint 35A that sews together outer edges 28a and 33a of the occupant side wall 33A and vehicle body side wall 28A in a generally circular shape. The temporary joint 54 is eccentrically located relative to the edging joint 35A by locating the center C1 at the rear of the center C2 of the edging joint 35A such that the rear edge 54a coincides with the rear edge 35a of the edging joint 35A. The two terminals 56 of the temporary joint 54 acting as the leading ends are located proximate the front end of the airbag 53. In operation of the airbag apparatus with the airbag 53 thus configured, the airbag 53 firstly inflates as a small-volume bag 49A with the temporary joint 54 kept jointed. Specifically, as shown in FIG. 17A, the small-volume bag 49A has such an inflated contour that is reduced in width in a left and right direction and prevented from unfolding forwardly while being allowed to unfold rearward fully. Accordingly, the small-volume bag 49A is capable of deploying quickly between a rear region of the ring of the steering wheel W and an abdomen of an occupant, thereby preventing the steering wheel W from hitting the occupant. Moreover, the small-volume bag 49A is capable of avoiding engagement with hands and/or arms of the occupant holding the steering wheel W. Then when the connecting element 43 is disconnected from the case, the temporary joint 54 is disjointed from the terminals 56 located proximate the front end of the airbag 53, and the airbag 53 is allowed to unfold forwardly as well as rearwardly along with disjointing of the temporary joint 54 (refer to double-dashed lines in FIG. 17B), and then fully inflate in a left and right direction as well, as shown in FIG. 17C.

That is, the airbag 53 also quickly arrests an occupant as the small-volume bag 49A in the initial stage of inflation, and then as holding the occupant from moving forward, disjoints the temporary joint 54 and inflates fully, thereby cushioning the head of the occupant softly, suppressing a reaction force, as the large-volume bag 50A. As a result, the airbag apparatus with the airbag 53 quickly prevents forward movement of an occupant with the small-volume bag 49A which is high in inner pressure and protects the head of the occupant softly with the large-volume bag 50A which is suppressed in inner pressure.

In this embodiment, especially, since the temporary joint 54 is so formed that the rear edge 54a coincides with the rear edge 35a of the edging joint 35, the airbag 53 (small-volume bag 49A) is allowed to unfold and inflate rearward fully in the initial stage of inflation, thereby covering the rear region of the steering wheel W quickly.

In the foregoing embodiments, furthermore, since the symmetrical configuration of the temporary joint 36154 causes disjointing to start from the leading end(s) (the top 37a of the projecting portion 37/the terminals 56) located proximate the center in a left and right direction, thereby inflating the airbag 25/53 in a well-balanced manner in a left and right direction.

In the foregoing embodiments, the temporary joint 36 of the airbag 25 is formed into a generally reverse-U shape opening rearward in such a manner as to divide an area of the bag body 26 (airbag 25) into two whereas the temporary joint 54 of the airbag 53 is formed into a generally circular shape in such a manner as to divide an area of the bag body 26A (airbag 53) into two. However, the contour of the temporary joint should not be limited thereby. For example, the temporary joint may be formed into such a shape as to partition the front end region of the airbag from the remainder. Further alternatively, the temporary joint may be formed into such a line that would partition the airbag partially. In such an instance where the temporary joint is formed into a line, the connecting element will be located at a terminal of the temporary joint farther away from the inlet port.

The airbags 25 and 53 of the foregoing embodiments do not include internally a tethering element for connecting the occupant side wall 33/33A and vehicle body side wall 28/28A and restraining a clearance between the walls. Even without such a tethering element, the airbags 25/53 are prevented from protruding toward an occupant and therefore protect the occupant adequately since the airbags 25/53 inflate firstly in a small volume with the connecting element 43 connected to the case 11 or vicinity thereof. Naturally the airbag may be provided inside with such a tethering element.

Although the foregoing embodiments of the invention have been described as applied to an airbag apparatus for a steering wheel, the application of the invention should not be limited thereby. The invention may also be applied to an airbag apparatus for a front passenger's seat. In the foregoing embodiments, moreover, the outer circumferential wall 27/27A of the airbags 25/53 is comprised of two walls (occupant side wall 33/33A and vehicle body side wall 28/28A) and the temporary joint 36/54 joins the walls 33/33A and 28/28A together. However, the temporary joint may also be formed to tuck a plurality of regions of one of those walls. Further, the location and/or number of the temporary joint, and the number of the connecting element also should not be limited to those described in the foregoing embodiments, but may be arbitrarily decided based on a protection mode of an occupant.

What is claimed is:

1. An airbag apparatus adapted to be mounted on a vehicle, the apparatus comprising an airbag folded up and housed in a housing for inflation with inflation gas and emergence from the housing,
the airbag comprising:
an outer circumferential wall made of flexible sheet material,
a temporary joint that joins parts of the outer circumferential wall together in an disjointable fashion, the temporary joint including a leading end that is so figured as to induce stress concentration and trigger disjointing; and
a connecting element that extends through an interior of the airbag from a vicinity of the leading end of the temporary joint and is disconnectably connected to the housing or a vicinity of the housing by a distal end thereof, the connecting element being configured to be disconnected from the housing or the vicinity thereof when an inner pressure of the airbag is increased,
wherein, in an initial stage of airbag inflation, the connection of the connecting element to the housing or the vicinity thereof makes areas of the outer circumferential wall of the airbag located outside of and in the vicinity of the leading end of the temporary joint pressed against each other due to an internal pressure owing to inflation gas so as to suppress a tensile force acting on the leading end of the temporary joint such that the temporary joint is kept jointed to make the airbag inflate in a small volume; and
wherein the airbag is increased in volume upon disjointing of the temporary joint due to disconnection of the connecting element.

2. The airbag apparatus of claim 1 further comprising on or in the vicinity of the housing an anchor mechanism that anchors the distal end of the connecting element and releases the leading end by actuation of an actuator.

3. The airbag apparatus of claim 1, wherein:
the temporary joint has a void region such that two terminals thereof are distantly located in the vicinity of the connecting element; and
the leading end of the temporary joint is comprised of the two terminals.

4. The airbag apparatus of claim 3 wherein the temporary joint is formed into a generally circle which is cut out at a part.

5. The airbag apparatus of claim 4 wherein the temporary joint is formed by sewing with a sewing thread.

6. The airbag apparatus of claim 5 wherein no back stitch is applied to the terminals and the sewing threads at the terminals are just left untreated.

7. The airbag apparatus of claim 4, wherein:
the airbag is configured for use for a steering wheel and the outer circumferential wall is comprised of an occupant side wall deployable toward an interior of a vehicle and a vehicle body side wall deployable on the side of the steering wheel, which have identical generally circular shapes;
the airbag further includes an edging joint that sews together outer edges of the occupant side wall and vehicle body side wall in a generally circular shape;
the temporary joint is smaller in diameter than the edging joint and is eccentrically located relative to the edging joint by locating a center of the temporary joint at the rear of a center of the edging joint; and
the two terminals of the temporary joint are located proximate a front end of the airbag.

8. The airbag apparatus of claim 7, wherein a rear edge of the temporary joint generally coincides with a rear edge of the edging joint.

9. The airbag apparatus of claim 1, wherein:
the airbag is configured for use for a steering wheel and the outer circumferential wall is comprised of an occupant side wall deployable toward an interior of a vehicle and a vehicle body side wall deployable on the side of the steering wheel, which have identical generally circular shapes;
the temporary joint joins the occupant side wall and vehicle body side wall together continuously on three sides of the airbag as fully inflated, from the left side to the right side via the front side except the rear side, in such a manner as to form a generally reverse-U shape; and
the temporary joint includes a projecting portion that is formed into such a shape as to project partially proximate a front end of the airbag and a top of the projecting portion constitutes the leading end of the temporary joint.

10. The airbag apparatus of claim 9 wherein the temporary joint is formed by sewing with a sewing thread.

11. The airbag apparatus of claim 1 wherein the outer circumferential wall of the airbag includes on an outer region of the leading end of the temporary joint a vent hole that is openable at disjointing of the temporary joint.
